(19) United States
(12) Patent Application Publication
(10) Pub. No.: US 2002/0051838 A1
(43) Pub. Date: May 2, 2002

(54) Filter bag consisting of filter paper for producing brewed beverages such as coffee or tea, a stack of filter bags of this type and methods of producing filter bags of this type

(76) Inventors: Carmen Koeppe, Schwalbach (DE); Christof Miltenberger, Schmitten/Ts. (DE); Corina Bachmann, Augsburg (DE); Marco Buhler, Konigstein (DE); Marga Lorenz, Siges (ES); Bernd Trebitz, Butzbach (DE)

Correspondence Address: ERIC L. PRAHL, Fish & Richardson P.C., 225 Franklin Street, Boston, MA, 02110-2804, US

(21) Appl. No.: 10/024,975

(22) Filed: Dec. 19, 2001

Related U.S. Application Data
(63) Continuation of application No. PCT/EP99/04911, filed on Jul. 13, 1999.

(51) Int. Cl. A47J 31/00; A23L 1/00

(52) U.S. Cl. 426/438; 99/279

(57) ABSTRACT

The invention is directed to a filter bag (10) consisting of filter paper for producing brewed beverages such as coffee or tea, comprising a holding space (17) for holding a substance, such as coffee grinds or tea leaves, and being made up of a folded filter sheet blank (1) having two filter sheet sides (11, 12). The filter sheet sides (11, 12) are of essentially identical shape and size, having one bottom edge (13) and two side edges (22, 24 and 23, 25). The side edges (22, 24; 23, 25) diverge upwards and include at their upper ends top edges (14, 15) for forming a filling opening (30), with the bottom edge (13) and the side edges (22, 24; 23, 25) of the two filter sheet sides (11, 12) being either connected with each other in a positive engagement relationship, in which case they form bottom and/or side strips (37 and/or 28, 29) in this area, or connected with each other in one integral piece in these areas, in order to form a filter bag (10). According to the invention, only the bottom and/or side strips (37 and/or 28, 29) connected with each other in a positive-engagement relationship are folded over toward one side of a filter sheet. As a result, the filter bags (10) retain their opened shape better. In a second invention, the filter bags (10) produced in accordance with the aforementioned features are readily stackable in a stack (18), being nested within one another while forming and retaining a holding space (17). This facilitates handling of the filter bags (10).

This invention relates to a filter bag consisting of filter paper for producing brewed beverages such as coffee or tea, comprising a holding space for holding a substance, such as coffee grinds or tea leaves, being made up of a folded filter sheet blank having two filter sheet sides of essentially identical shape and size, said filter sheet sides having one bottom edge and two side edges, with the side edges diverging upwards and including at their upper ends top edges for forming a filling opening, with the bottom edge and the side edges of the two filter sheet sides being either connected with each other in a positive engagement relationship, in which case they form bottom and/or side strips in this area, or connected with each other in one integral piece in these areas, in order to form a filter bag.

A filter bag of the type initially referred to is known from EP 0 741 988 A1, for example. In this specification, the filter sheet has its bottom edges folded over to form two adjacent filter sheet sides of essentially trapezoidal shape when viewed from above, which are interconnected at their two side edges by seams produced as by crimping, pressing, adhesive-bonding, bonding by stamping, joining by embossing, etc., thus forming side strips. In this context, either the side strips project into the holding space or they protrude outwards. The filter bags have at their top end arcuate shaped outer edges into which a holder made of wire can be inserted. On the one hand the filter bag is therefore easy to suspend and insert in a vessel, on the other hand it is given a stable form that prevents it from collapsing during the extraction process.

Further, from EP 0 107 174 B1 there is known a filter bag of the type initially referred to, in which the two filter sheet sides of a filter sheet are likewise configured in roughly trapezoidal shape when viewed from above and in which the symmetry axis of the filter sheet—meaning the line of transition from the one filter sheet side to the other filter sheet side—is formed by the side edges that diverge upwards at an angle on the one side of the filter sheets and also represent the course of the fold. The opposing side edges and the bottom edges are in positive engagement with each other, thus forming side strips in the area of which the filter sheet sides are fixedly interconnected mechanically. Hence the two filter sheet sides lie one on top of the other when the filter sheet is folded. The two filter sheet sides are mechanically interconnected by means of the edges diverging upwards at an angle on the one side and also by means of the edges configured at the bottom, so that they form edge strips. It is thus possible to obtain a holding space between the two filter sheets, which can be used when the filter bag is unfolded to hold substances such as coffee grinds or tea leaves.

On account of the type of blank and the further processing of these filter bags, it is difficult for the bags to retain their open form once opened to form a holding space and when inserted in a receiving chamber of a filter housing, i.e., they will readily fold together again unless they are pressed into the receiving chamber of the filter housing by hand with some considerable force, causing the side strips to yield sideways. If this is not done correctly by the user the filter bags may fold together again during brewing and the water will run past the outside of the filter bag without passing through the substance. This inserting operation is bothersome and inconvenient.

For sales purposes, numerous filter bags of this type are placed side by side or one on top of the other so that they form a stack; this is the case, for example, with the 1×4 filter bags of the company Melitta-Werke Bentz & Sohn in Minden, Germany, or with the No. 4 filter bags of the company Hima AG in Rotkreuz, Switzerland. Such a loose stack of filter bags is packed in a box for sale on the market. With this type of packaging it is often difficult for the user to take a single filter bag from the stack in the box because it is difficult to handle the separation of the filter bags. It frequently happens that several filter bags are removed simultaneously from the packaging.

It is an object of the present invention to provide a filter bag which, on the one hand, makes it easier for the filter bag to be inserted in a receiving chamber of a filter housing and, on the other hand, essentially retains its open shape after being inserted in the receiving chamber. Further, it is an object of a second invention to configure these filter bags such that they can be stacked with minimal stacking dimensions, with the stack affording ease of handling of said filter bags, particularly when removing them from the packaging. Still further, it is an object of a third invention to produce a packaging box into which the filter bags of the invention are easy to insert and from which they are easy to remove one at a time. Further, it is an object of a fourth invention to provide a method of manufacturing filter bags of this type, which method affords ease and economy of filter bag production. Finally, it is an object of a fifth invention to provide a method of making a stack of such filter bags that can be performed easily, economically and as quickly as possible.

The object of the first invention for the filter bag of the type initially referred to is accomplished in accordance with the invention in that both side strips are folded around toward one side of a filter sheet. By folding the side strips around toward one side of a filter sheet before the filter bags are combined in a stack, the filter bag opens as soon as it is inserted in the receiving chamber of a filter housing. The circular edge of the opening of the receiving chamber of the filter housing presses together the two areas of the side strips—said side strips starting at the point of transition to the arcuate shaped top edge of the filling opening of the filter bag—in such a way that the top edge takes the form of an essentially circular filling opening that is also retained later. This results from the fact that the force exerted by the fold on the inner filter sheet always tries to bring this filter sheet into an outward bending form. The outer filter sheet also displays an outward bent form in the area of the side strip and is so always likewise inclined to open outwards, thus enlarging the filling opening of the filter bag.

As a result of this invention it is particularly easy to insert a filter bag in the receiving chamber of a filter housing without it automatically rising a little out of the receiving chamber, as is the case with the filter bags initially referred to. The user is no longer required to press the filter bag apart, as is the case with prior-art bags, in order to then fold over the side edges and, as the case may be, also the bottom edge in order finally to be able to insert the filter bag in the filter insert so that it fits. After the filter bag of the invention is inserted in the receiving chamber of the filter housing it lies practically flush against the wall of the receiving chamber all round. The filter bag retains a secure seat within the receiving chamber and does not fold together again slightly due to inner stresses. Brewing errors are ruled out with such a filter bag because the filter bag is no longer able to fold together again even when wet. As already mentioned, the height of the projecting edge of the top-most filter bag is also reduced as a result. This means that a larger number of filter bags can be accommodated in packaging of the same size.

Generally, it is possible for filter bags of all types to be nested within one another in the manner disclosed in the invention.

With the filter bag known from EP 0 107 174 B1 it is an advantage if the joining border at the bottom edge and/or side edge is made to be as narrow as possible. The height of the projecting edge of the top-most filter bag can thus be reduced, enabling at the same time the number of nestable filter bags to be increased while the packaging size is maintained unchanged.

With the filter bag known from EP 0 107 174 B1 it also is an advantage if the bottom edge and/or side edge equipped with the joining border is folded over. This can also reduce the height of the projecting edge of the top-most filter bag and therefore increase the number of filter bags stackable in a box.

In an advantageous configuration of the present invention according to the features of patent claim 2, the two filter sheet sides are interconnected at the bottom edge of the filter bag by means of a fold, and at the two side edges by means of seams. This configuration of the filter bags corresponds to EP 0 741 998 A1. In addition to the advantages already described, this configuration results without any further measures in a minimal height of the projecting edge of the top-most filter bag above the next filter bag. A particularly narrow joining border is not needed, therefore, nor does the joining border at the bottom edge have to be folded over.

A further advantage of this configuration of the invention over the filter bag according to EP 0 107 174 B1 is that after the filter bag is inserted in a filter insert it no longer slips up again. This is often the case with a filter bag according to EP 0 107 174 B1 on account of the joining border at the bottom edge, necessitating an elaborate folding over of this joining border, for example, or similar steps.

A further advantage of joining the two filter sheets by way of the folded bottom edge is that there is only a fold and no seam or embossing or the like at the bottom edge, thus enabling the brewed coffee to flow out unobstructed.

The features of patent claim 2 are intended to protect those filter bags whose filter sheet sides are connected with each other in one integral piece at the bottom and whose side strips are in positive engagement with each other, thus forming side strips that are subsequently folded around toward one filter sheet side in accordance with the invention. In this embodiment there is no side strip in the bottom area, resulting in the advantage that the filter bag can be inserted particularly well and deep into the receiving chamber of a filter housing, where it makes stable contact with the edge and bottom of the receiving chamber.

Through the features of patent claim 3 the tendency of the filter bag to open when it is inserted in the receiving chamber of a filter holder is further improved and a more uniform opening cross section of the filter bag obtained because the inner stresses of deformation arising from the folding of the side strips are partly eliminated as the result.

With the features of patent claim 4 a filter bag shape is claimed in which one side edge and the bottom are connected with each other by positive engagement, thus forming side strips that are subsequently folded around toward one filter sheet side. This filter bag is also readily insertable in the receiving chamber of a filter housing without the filter sheet sides approaching each other and hence reducing their holding space, and without them wandering upwards.

The second invention relates to a stack of filter bags in accordance with the features of patent claim 5. The roughly V-shaped or, when seen from above, essentially trapezoidal filter bags are no longer placed one on top of the other—as is known from the prior art—but are nested within one another. Hence the top-most or first filter bag always presents itself to the user with its holding space automatically open for removing from the packaging box because the filter bags are not made to lie flat on top of each other but display said holding space. The top-most filter bag projects with its top edge encompassing the filling opening slightly beyond the underlying filter bag so that a user can easily grip this projecting edge, push it a little inward, hold this filter sheet side between thumb and index finger, and finally pull the filter bag with ease out of the packaging. The projecting edge also guarantees that a user only pulls a single filter bag out of the packaging. Hence there is far less risk of several filter bags being pulled out of the packaging at a time, as may often happen with prior-art bags, particularly in cases where the boxes are newly opened and still full. This facilitates the removal of discrete filter bags and their handling.

A further advantage of the stack of filter bags of the invention is that the filter sheet sides of the individual filter bags do not come to rest directly on top of each other by nesting the filter bags within one another but that the next filter bags are always in between. Consequently, the individual filter bags have a pocket-like shape and hence at least a certain opening of their holding space already when they are packed. When a filter bag of this type is then withdrawn from the stack the user is able, with the aid of this already available filling opening, to fully unfold the filter bag easily without any notable force and without any undesired creasing. All that is required is for the user to reach inside the existing filling opening and press apart the filter sheet sides of the filter bag. This operation can be dispensed with, however, when inserting the filter bag in the receiving chamber of a filter housing because unfolding occurs automatically on account of the given dimensions of the top edge of the filter bag and the inner diameter of the receiving chamber of a filter housing. This is so because when the filter bag is inserted it is pressed together by its side edges in such a way that the filter bag automatically opens and makes full contact all round with the inner wall of the filter housing.

Compared to the prior art in which the filter sheet sides of the filter bags are pressed together one on top of the other in the packaging so that upon removal they are difficult to press apart and unfold, this opening of the holding space of the filter bag is materially simplified by the invention. The bothersome process of separating one of the filter sheets of the filter bag using your finger or similar measures is eliminated.

According to a third invention disclosed by the features of patent claim 6, a packaging box with a stack of filter bags inside is provided, with the filter bags being previously combined to form a stack in accordance with the features of patent claim 5. With the packaging box being preferably a right parallelepipedal hollow body, i.e., all the cardboard sides are rectangles, a stack of filter bags is readily insertable in the space of the box. The distance between the two end panels and the distance between the front panel and the rear panel is calculated so that when the stack of filter bags is inserted they are pressed together by the front and rear panel in such a way that they spread out to the sides. Hence the sideways spread is defined by the pressing together of the filter bags from the front and from the rear so that when the stack is inserted in the space of the packaging box the spreading stops just upon reaching the end panels of the box. In the packed state the stack still has a three-dimensional shape such that the top filter bag forms a limited holding space of a size sufficient for a hand to reach inside in order to remove the filter bag from the stack and pull it out of the box.

It is an advantage when stacking if, in accordance with patent claim 1, the side edges of a filter bag that are formed by joining the two filter sheet sides are folder over, as they then have practically no disturbing effect on the stack height because only one paper layer only ever lies on top of the other paper layer. While the folded side strips and the one filter sheet side together form three layers of paper per filter bag, this thickness does not interfere with the nested arrangement of filter bags because these diverge outwards at an angle. This has less of an effect on the stack height and more of an effect on the stack depth, which is no problem because—as with conventional packaging boxes—there is sufficient space available if the same depth is to be used to the full. A far more important consideration is the good handling of the filter bags, which require no special concentration to be removed and no great dexterity. Subsequently inserting the filter bag in the receiving chamber of a filter housing is also particularly agreeable because the bag opens immediately and settles against the inner wall of the receiving chamber of the filter housing.

The features of patent claims 7 and 8 provide for methods of manufacturing a filter bag that displays both the features of patent claim 2 and the features of patent claim 4. The filter bags are simply cut out of a filter sheet material, folded along the folding line, and mechanically joined at the corresponding side edges. A practical joining method is crimping or bonding by stamping or joining by embossing, whereby instead of using additional materials for the joining, the filter paper is deformed in its microstructure in such a way that both filter sheet sides intimately interlock in the side strip and clutch each other in the micro range, i.e., the materials of the two filter sheet sides virtually interlock through plastic deformation.

To fold over the side edges it is possible to use, for example, suction lifting devices or similar fixtures, which are raised when the rest of the filter bag is held level by hold-down devices and then pressed by means of a punch against the one filter sheet side. It is also conceivable, however, for the side strips to be inserted one after the other in slots and then for the rest of the bag to be folded through 180° along the folding edge, and for the folded side edges then to be pressed against the filter sheet side. Further folding methods, not mentioned here in any further detail, may also be contemplated for this folding operation.

According to the features of patent claim 9, after the filter bags are opened they are nested within one another to the point where the outer surface of the bottom of the filter bag that is in process of being nested rests against the inner surface of the bottom of the other filter bag. After the stack has been assembled in this manner, a forming punch having the inner dimensions of the holding space can be pressed into the holding space of the top-most filter bag so that the filter bags come to lie close together. This requires, however, a suitable tool to support the stack from the outside so that the stack can be pressed together with relatively high pressure. The result is a stack of numerous filter bags of particularly compact height, width and depth that can be inserted without difficulty in a packaging box.

Further features, application possibilities and advantages of the present invention will become apparent from the subsequent description of embodiments of the invention illustrated in the Figures of the accompanying drawings. In this context, all features described or depicted, whether individually or in any combination, form the object of this invention irrespective of their summarization in the patent claims or the cross references of the latter, and independent of their wording and representation in the description and the drawings, respectively. In the drawings,

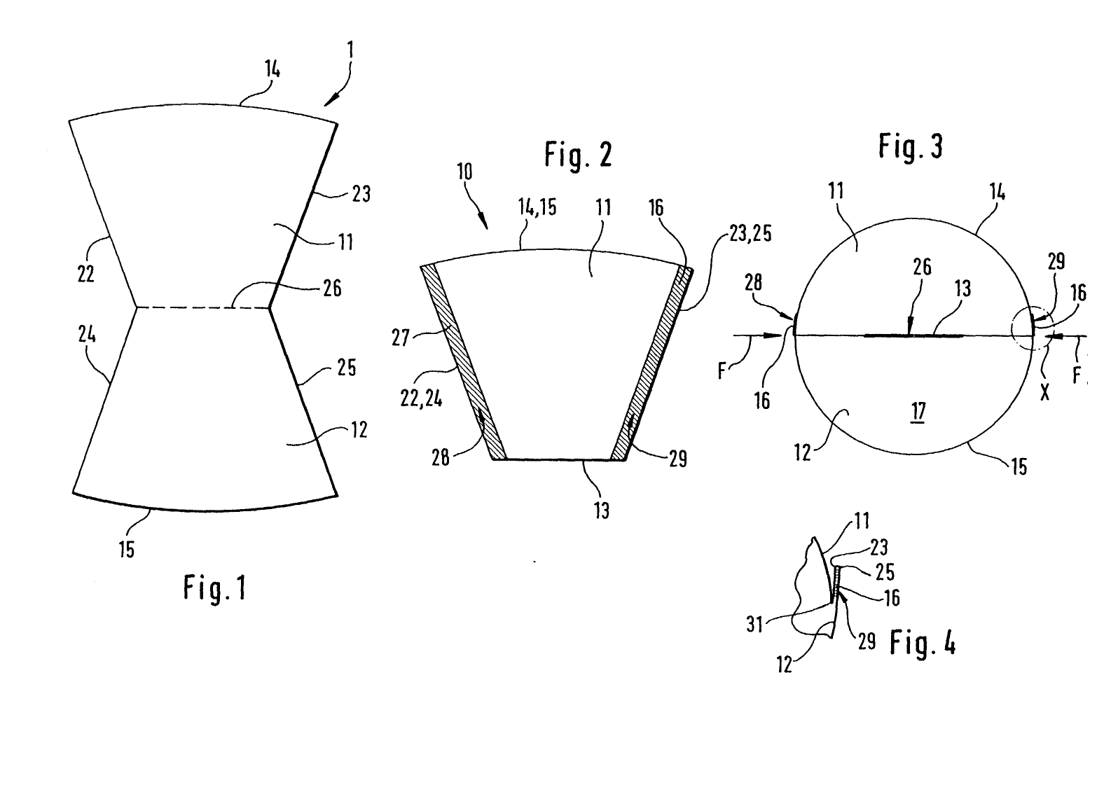

FIG. 1 is a schematic illustration of an embodiment of a filter bag of the invention in unfolded condition;

FIG. 2 is a schematic illustration of the filter bag of FIG. 1 in folded condition;

FIG. 3 is a schematic top plan view of the filter bag of FIG. 2, but in opened condition, showing the side edges folded over in accordance with a first invention;

FIG. 4 is a view of a detail X of FIG. 3, showing the side strips folded over toward one side on an enlarged scale;

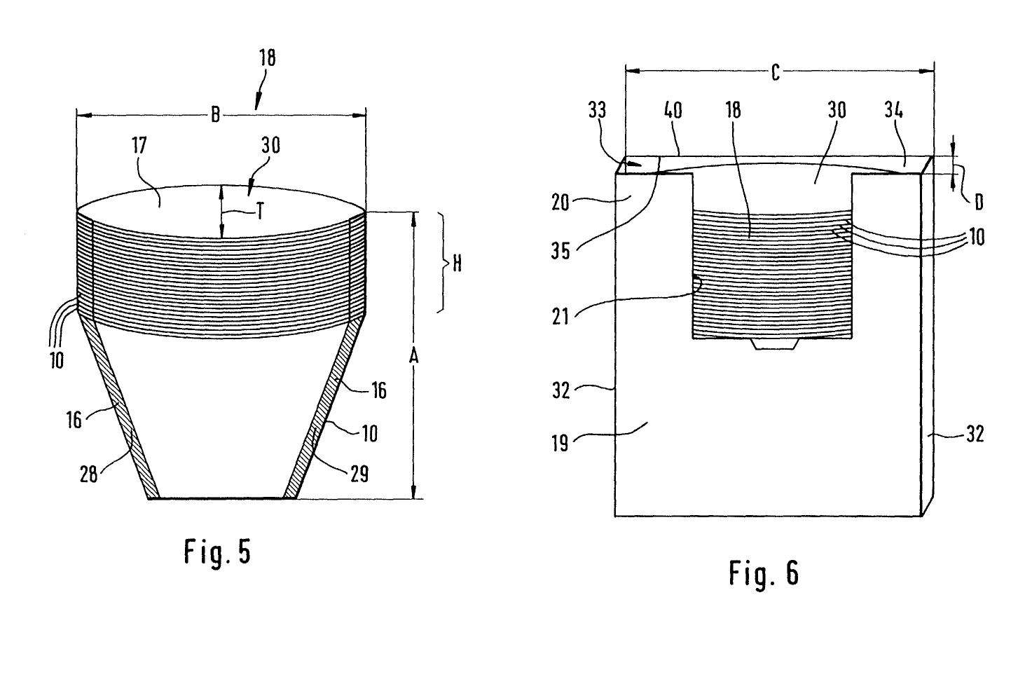

FIG. 5 is a view of a stack of nested filter bags of the type shown in FIG. 3, according to a second invention;

FIG. 6 is a view of the stack of filter bags nested as shown in FIG. 5 and inserted in a packaging box, according to a third invention; and

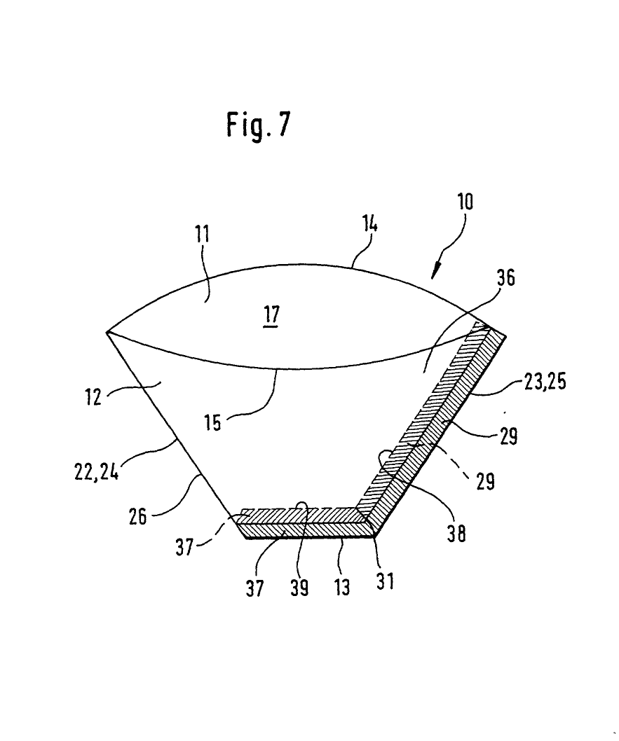

FIG. 7 is a schematic illustration of a second embodiment of a filter bag, in which the side edges are not bent or folded over as yet as shown in the first embodiment of FIG. 3, the folding over being, however, indicated by dashed lines.

FIG. 1 shows a filter paper blank 1 of a filter bag 10 in an unfolded state. The filter paper blank 1 is made of a filter paper material such as that used for filter bags currently available on the market for brewing coffee. The filter paper blank 1 comprises two essentially congruent filter sheet sides 11, 12 which are essentially configured to be roughly trapezoidal in shape, as is shown in particular in FIGS. 1, 2 and 7. According to FIGS. 1, 2 and 7 the two filter sheets 11, 12 each have one bottom edge 13, two upwardly diverging side edges 22, 23, 24, 25, and slightly upwardly curved top edges 14, 15. The top edges 14, 15 are slightly curved upwards so that, after the filter bag 10 has been opened, they essentially form a circular filling opening 30, which then also extends in essentially horizontal direction in relation to the bottom edge 13. For this reason the views presented in FIGS. 1, 2 and 7 show filter sheet sides 11, 12 which are only “essentially trapezoidal”. At the bottom edge 13 the two filter sheet sides 11, 12 are connected with each other in one integral piece, i.e., the filter paper blank 1 and hence the filter bag 10 are cut as a single piece out of a sheet of filter paper material. According to FIGS. 1 to 5 the bottom edge 13 forms the crease fold 26 along which the two filter sheet sides 11 and 12 are folded or creased.

In FIG. 2 the filter bag 10 is presented in a folded state. The two filter sheets 11, 12 have at the bottom edge 13 the crease fold 26 which is folded to less than 180° so that the two filter sheet sides 11, 12 come to lie one on top of the other. At the side edges 23, 25 and 22, 24, which lie one on top of the other, the two filter sheet sides 11, 12 are interconnected with one seam 16, 27 respectively. Seam 16 can be a joining border, an embossing, an adhesive strip or some other mechanical joint providing for positive engagement of the two filter sheet sides 11, 12 at the side edges 23, 25 and 22, 24. In FIG. 2 the top edges 14, 15 of the two filter sheet sides 11, 12 come likewise to lie one on top of the other, i.e., there is no filling opening 30 when the filter bag is in the folded flat position. The seams 16, 27 form side strips 28, 29 extending substantially parallel to the side edges 23, 25 and 22, 24. In this embodiment the side strips 28, 29 are relatively wide because instead of using additional joining elements for the joining operation, the paper is held in intimate interfitting engagement preferably by an embossing and deep-drawing process, thus establishing a positive-engagement relationship between the two filter sheet sides 11, 12 in the side strips 28, 29. This joint is referred to as the seam 16, although it is not sewn in the real sense.

FIG. 3 shows the invention filter bag 10 of FIG. 2 in an opened state. In this state the top edges 14, 15 form a roughly circular ring, albeit only in the ideal case. In practice the opening cross section of the filling opening 30 will always adopt a slightly oval or other form because, on the one hand, the paper is flexible and, on the other hand, the inner stresses occurring due to the joining of the two filter sheet sides 11, 12 by their side strips result in the cross section of the filling opening 30 being slightly deformed. A holding space 17, which is used to hold a substance, preferably coffee grinds or tea leaves, forms between the opened or spaced-apart filter sheet sides 11, 12 of the filter bag 10. This filter bag 10, presented in FIG. 3, can be inserted in a receiving chamber (not shown) of a filter housing of an electric household coffee-maker operating by the percolator principle, i.e., one which allows hot water to flow without pressure from above into the holding space 17, or in a hand filter made of plastic, porcelain, etc. from the company Melitta, for example. For brewing purposes the hand filter is placed on a carafe or some other vessel.

The two side strips 28, 29 are folded through roughly 90° around toward one filter sheet side 11, as can be seen in particular in FIGS. 3 and 4. The side strips 28, 29 may stand slightly off the outer surface of the filter sheet side 11 because the crease folds 31 of the side strips 28, 29 are still elastic within low limits during the folding operation and so will still spring back slightly. As becomes clearly apparent from FIGS. 3 and 4, the crease fold 31 causes the filter sheet side 11 to execute an essentially circular movement toward the other side edge 22 in the circumferential direction. The filter sheet side 12 extends in the other direction along roughly a circle. In the area of the seams 16, 27 the filter sheet sides 11, 12 extend tangentially away from the seams 16, 27. This ensures that the filter bag 10 always strives to open as soon as a force F acts from outside, e.g. from both sides via the side strips 28, 29, causing the filter bag 10 to open automatically.

As becomes apparent from FIG. 5, the cross section of the filling opening 30 in the stack 18 of nested filter bags 10 is shaped in an essentially oval configuration, i.e., the width B is bigger than the depth T, whereas in FIG. 3 the width B is roughly equal to the depth T. While a filter bag 10 is being inserted in a receiving chamber of a filter housing (not shown), the side strips 28, 29 are moved toward each other, i.e., the width B diminishes and an essentially circular cross section gradually develops at the filling opening 30. This is possible in particular on account of the prior folded side strips 28, 29, because the crease folds 31 made on the two side strips 28, 29 are plastically folded over in such a way that the filter bag 10 always strives to adopt an open filling cross section at the filling opening 30. Folding of the side strips 28, 29 is performed after the production of the folded filter bag 10 as shown in FIG. 2. An opened filter bag 10 with side strips 28, 29 folded over is shown only in FIGS. 3, 4, 5 and 7.

FIG. 5 shows a stack 18 of nested filter bags 10. In this arrangement, each filter bag 10 is inserted between the filter sheets 11, 12 of the next filter bag 10, meaning that each subsequent filter bag is inserted in the holding space 17 of the preceding filter bag 10 deep enough for its bottom edge 13 to substantially rest against the inner side of the bottom edge 13 of the previously inserted filter bag 10. Hence each of the filter bags 10 is situated in that section of the next filter bag 10, which in the opened state forms the holding space 17.

As becomes apparent from FIG. 5, numerous filter bags 10 are nested within one another in the way described. Each of the filter bags 10 protrudes with its top edges 14, 15 a certain height above the top edges 14, 15 of the next filter bag 10 lying underneath. This height equals 0.1 mm, for example, which is approximately the thickness of the filter paper. The plurality of nested filter bags 10 thus gives rise to an overall height identified in FIG. 5 by reference character A.

In FIG. 6 the stack 18 of filter bags 10 is inserted in a packaging box 19. The packaging box 19 has in its front panel 20 a rectangular cutout 21 extending in the direction of the nested filter bags 10 and corresponding in this direction with roughly the height H (FIG. 5), which results from the superposed top edges 14, 15. The packaging box 19 is essentially a right parallelepipedal hollow body whose end panels 32 are significantly narrower in width than the width C of the front and rear panels 20, 34. The dimension C of the packaging box 19 is somewhat bigger than the dimension B of the filter bags 10 combined in the stack 18. Similarly, the depth D of the end panels 32 of the packaging box 19 is smaller than the depth T of the filter bags 10 packed on the stack 18 (FIGS. 5 and 6). This means that when the stack 18 is inserted in the space 33, the stack 18 is pressed together by the front panel and the rear panel of the packaging box 19 in such a way that the stack is lengthened in its width B, meaning that the filling opening 30 adopts a narrow oval shape or even the form of a figure-of-eight that is not quite closed, i.e., at the edge the opening remains round to both sides while the center of the stack 18 is pressed together, albeit only to the extent that a user can still reach easily into the deformed holding space 17 in order to take out a filter bag 10 with his hand.

The packaging box 19 has a lid, which is not visible in the drawing because in FIG. 6 it is flipped open toward the rear panel 34, with the upper edge 35 of the rear panel 34 forming the folding plane. The lid is shaped to close not only the access opening 40 of the packaging box 19 but also the cutout 21 at the same time. The cutout 21 provided in the packaging box 19 enables the user to grip the top-most filter bag 10 of the stack 18 and take it out of the packaging box 19 until the end of the stack. In so doing, the user can press the protruding height of the top-most filter bag 10 slightly inwards and in this position can grip the filter bag 10 extensively from the outside as well as the inside and then lift said filter bag 10 up and out of the stack 18 and the packaging box 19.

On account of the nested arrangement of the filter bags 10, the filter sheet sides 11, 12 have at least a certain filling opening 30 so that the filter bag 10 that was pulled out of the packaging box 19 already displays a certain pocket-shaped form in this state. Hence the holding space 17 is automatically present, at least to a certain extent, when the filter bag 10 is removed. With the aid of said opening the user can then pull the filter bag 10 completely apart and hence completely unfold the holding space 17. Then the user can insert the unfolded filter bag 10 in a filter chamber of a filter housing (not shown) of an electric household coffee-maker. Through the already folded over side strips 28, 29 the filter bag 10 rests practically completely against the inner wall of the filter housing. The folded over side strips 28, 29 also promote the previously described automatic unfolding of the holding space 17 of the filter bag 10. As a result of the folded bottom edge and, hence, the lack of a seam in this area, the filter bag 10 remains without further ado in the filter insert and does not slip upwards. The user can now fill the filter bag 10 with, for example, coffee grinds.

FIG. 7 shows a second embodiment of a filter bag 10. To avoid repetitions the same reference numerals are applied as those used in FIGS. 1 to 6. Unlike the filter bag according to FIGS. 1 to 6, this filter bag has its crease fold or folding axis 26 on the left side edges 22, 24, i.e., it is in this area that the filter sheet edges 11, 12 are connected with each other in one integral piece. In this embodiment, the bottom edge 13 and the side edges 23, 25 form a positive-engagement relationship with each other, obtained preferably by pressing, forming in this manner the bottom strip 37 and the side strip 29.

After production of the filter bag 10, as shown in FIG. 7, the bottom strip 37 and the side strip 29 are folded around toward the outer surface 36 of the filter sheet side 12 so that said strips 37, 29 practically engage the outer surface 36, as indicated by the dashed lines 38, 39. When the filter bags 10 thus produced are nested within one another, as shown in the first embodiment of the filter bag 10 of FIGS. 5 and 6, the crease fold 31 formed on the outer surface of the filter bag 10 makes abutting engagement with the crease fold 31 formed in the holding space 17 of the other filter bag 10. This gives rise likewise to a very close-sitting stack 18 which, when inserted in the packaging box 19, has again holding spaces 17 that are slightly pressed together for greater ease of removal.

1. A filter bag (10) consisting of filter paper for producing brewed beverages such as coffee or tea, comprising a holding space (17) for holding a substance, such as coffee grinds or tea leaves, being made up of a folded filter sheet blank (1) having two filter sheet sides (11, 12) of essentially identical shape and size, said filter sheet sides (11, 12) having one bottom edge (13) and two side edges (22, 24 and 23, 25), with the side edges (22, 24; 23, 25) diverging upwards and including at their upper ends top edges (14, 15) for forming a filling opening (30), in which, on the one hand, the bottom edge (13) is connected by positive engagement to form a filter bag (10) and, on the other hand, the side edges (22, 24; 23, 25) are fixedly connected with each other, so that the latter form side strips (28, 29),
characterized in that the side strips (28, 29) connected with each other in a positive-engagement relationship are folded over toward the outer surface of a filter sheet side.

2. The filter bag as claimed in claim 1,
characterized in that the bottom edges (13) of the filter sheet sides (11, 12) are connected with each other in one integral piece, and the upward diverging side edges (22, 24; 23, 25) of the filter sheet sides (11, 12) are in positive engagement with each other.

3. The filter bag as claimed in claim 2,
characterized in that, as a result of the positive engagement, the side edges (22, 24; 23, 25) form side strips (28, 29), and the side strip (28) on the one side of the filter bag (10) is folded in opposite direction to the side strip (29) on the other side of the filter bag (10).

4. The filter bag as claimed in claim 1,
characterized in that

6. A packaging box containing a stack of filter bags according to the features of patent claim 5,
characterized in that the packaging box (19) is essentially a right parallelepiped whose width (C) and depth (D) are dimensioned such that the holding spaces (17) of the nested filter bags (10) adopt a shape such that the topmost filter bag (10) of the stack (18) can be readily grasped by hand by its inner and outer sides to be removed from the stack (18) and hence from the packaging box (19) in upward direction.

7. A method of manufacturing a filter bag according to the features of claim 2,
characterized by the steps of initially cutting out a filter sheet in such manner that two essentially trapezoidal attached filter sheet sides (11, 12) forming a filter paper blank (1) are produced, with the shortest, bottom edges (13) forming the folding axis (26) of the filter paper blank (1), folding over the filter sheet sides (11, 12) along the folding axis (26) in such manner that both filter sheet sides (11,12) come to lie one on top of the other, subsequently connecting the side edges (22, 23, 24, 25) of the filter sheet sides (11, 12) with each other in a positive-engagement relationship, and, in a final operation, folding over the side strips (28, 29) in their longitudinal direction such as to be in a facing, adjacent or even extensively engaging relationship with an outer surface (36) of a filter sheet side (11).

8. A method of manufacturing a filter bag according to the features of claim 4,
characterized by the steps of initially cutting out a filter sheet in such manner that two essentially trapezoidal attached filter sheet sides (11, 12) forming a filter paper blank (1) are produced, with the side edges (22, 24) of one side forming the folding axis (26) of the filter sheet, folding over the filter sheet sides (11, 12) along the folding axis (26) in such manner that both filter sheet sides (11, 12) come to lie one on top of the other, subsequently connecting the side edges (23, 25) of the other side and the bottom edges (13) of the filter sheet sides (11,12) with each other in a positive-engagement relationship to form side strips (29, 37), and, in a final operation, folding over the side strips (29, 37) in their longitudinal direction such as to be in a facing, adjacent or even extensively engaging relationship with an outer surface (26) of a filter sheet side (12).

9. A method of producing a stack of filter bags upon their manufacture according to the features of claims 7 or 8,
characterized by the steps of initially opening the filter bags (10), pushing a filter bag (10) thus pre-formed into the holding space (17) of a correspondingly pre-formed further filter bag (10) until the outside of the bottom edge (13) of the pushed-in filter bag (10) essentially rests against the inside of the bottom of the receiving filter bag (10), and compressing a stack (18) assembled in this manner by the front and rear panels (20, 34) of a box to an extent significantly reducing the volume of the holding space (17).
